(19) United States
(12) Patent Application Publication
(10) Pub. No.: US 2020/0107667 A1
(43) Pub. Date: Apr. 9, 2020

(54) CONTOURED DOUBLE WALLED FLUID CONTAINER WITH INTERNAL COMPARTMENT

(71) Applicant: DYLN LIFESTYLE, LLC, Irvine, CA (US)

(72) Inventor: Dorian R. Ayres, Costa Mesa, CA (US)

(73) Assignee: DYLN LIFESTYLE, LLC, Irvine, CA (US)

(21) Appl. No.: 16/586,138

(22) Filed: Sep. 27, 2019

Related U.S. Application Data
(60) Provisional application No. 62/743,493, filed on Oct. 9, 2018.

(51) Int. Cl. A47J 31/00; A47J 31/44; A47G 19/22

(52) U.S. Cl. CPC A47J 31/005; A47G 19/2205; A47J 31/4403

(57) ABSTRACT

Provided is a container for drinking fluids. The container includes an outer element having an outer base and an outer sidewall collectively defining an outer cavity. The container further includes an inner element having an inner base and an inner sidewall collectively defining an inner cavity. The inner element is coupled to the outer element and is disposed within the outer cavity. The inner element is sized in relation to the outer element such that a gap extends between the inner sidewall and the outer element, and between the inner base and the outer element. The inner sidewall being configured to define a first diameter adjacent the inner base and a second diameter spaced from the inner base that is less than the first diameter.

### CROSS-REFERENCE TO RELATED APPLICATIONS

This application claims the benefit of U.S. Provisional Application No. 62/743,493, filed Oct. 9, 2018, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a drinking fluid container, and more particularly, to a contoured, double walled, drinking fluid container having an internal diffuser.

### 2. Description of the Related Art

Personal hydration includes the need for portable drinking fluid containers and bottles. Because of the sustainability and environmental issues associated with plastic and single use water bottles, consumers are attracted to reusable containers as such as stainless steel water bottles. Also, stainless steel bottles can be formed to be free of BPA, lead or other toxins making for a healthier container. In addition, consumers have recognized the health benefits of treated drinking fluids such as alkaline water. In this regard, there is a need in the art for combining the benefits of reusable containers in combination with the easy availability of treated fluids such as alkaline water.

Alkaline water is understood to be beneficial to health for maintaining physical stability and helping to deal with acid buildup in the body in both healthy individuals and those with conditions that cause acidification of the blood. Alkaline water is said to aid in digestion and to also assist in reducing free radicals and thus protecting DNA structures. In addition, in most instances alkaline water has the characteristic of smaller water clusters, and as such has been identified as allowing the body to more easily absorb the water.

Generally, alkaline water is obtained by water electrolysis and/or through chemical treatment by mineral agents. In many prior art devices for creating alkaline water, electricity is used in association with an apparatus, or otherwise have complex structures that are not conducive for treating drinkable fluids in a portable manner. A discussion of the types and systems for creating alkaline water are described in Chung, U.S. Publication No. 2007/0221556, published Sep. 27, 2007 and entitled Container for Reducing Alkaline Water, the substance of which is incorporated herein by reference.

Prior art devices also disclose the use of mineral agents in fluid vessels, to allow untreated water to come in contact with the agents to form alkaline water. Such prior art devices, however, include multi-part structures that are not user friendly and may not remain fixed in a vessel, as intended, or otherwise use an undesirable amount of volume within a vessel and do not facilitate the flow of water around the mineral agents.

Furthermore, many prior art devices may include an undesirable appearance, and may have inefficient thermal qualities. As such, there is a need in the art for a visually appealing, thermally efficient portable fluid vessel capable of treating the drinking fluid. Various aspects of the present disclosure address this particular need, as will be discussed in more detail below.

### BRIEF SUMMARY

In accordance with one aspect of the present disclosure, there is provided a container for drinking fluids. The container includes an outer element having an outer base and an outer sidewall collectively defining an outer cavity. The container further includes an inner element having an inner base and an inner sidewall collectively defining an inner cavity. The inner element is coupled to the outer element and is disposed within the outer cavity. The inner element is sized in relation to the outer element such that a gap extends between the inner sidewall and the outer element, and between the inner base and the outer element. The inner sidewall being configured to define a first diameter adjacent the inner base and a second diameter spaced from the inner base that is less than the first diameter.

The inclusion of a gap between the inner element and the outer element may enhance the thermal insulation of the container to mitigate unwanted heat transfer to or from the drinking fluid. The container may also include contoured sidewalls both externally and internally. The external contour may enhance the appearance of the container. The internal contour may serve two purposes, namely, maximizing the fluid storage capacity of the container, while also promoting fluid flow around an internal diffuser cartridge to treat the drinking fluid with a selected compound.

According to another aspect of the present disclosure, there is provided a container for holding drinking fluids, with the container being usable with a diffuser cartridge. The container includes an outer element having an outer base and an outer sidewall collectively defining an outer cavity. An inner element includes an inner base and an inner sidewall collectively defining an inner cavity. The inner element is coupled to the outer element and is disposed within the outer cavity and is sized in relation to the outer element such that a gap extends between the inner element and the outer element. The inner sidewall is configured to define a first diameter adjacent the inner base and a second diameter spaced from the inner base that is less than the first diameter. A retaining wall is coupled to the inner base and is engageable with the diffuser cartridge.

The outer sidewall may be of a third diameter adjacent the outer base and of a fourth diameter at a midsection thereof spaced from the outer base, with the fourth diameter being less than the third diameter.

The outer sidewall and the inner sidewall may be positioned about a central axis, and the distance between the outer sidewall and the inner sidewall may vary within different cross sections taken perpendicular to the central axis. The outer sidewall and the inner sidewall may be configured such that the gap may define a first area in a first cross section taken perpendicular to the central axis adjacent the inner base and a second area in a second cross section taken perpendicular to the central axis spaced from the inner base, with the first area being less than the second area.

The outer sidewall may include an external concave configuration. The inner sidewall may include an internal convex configuration.

The gap may be of a fluid pressure having a magnitude of less than atmospheric pressure.

The inner base may be separated from the outer base, such that a portion of the gap extends therebetween.

The retaining wall may be cylindrical. At least a portion of the retaining wall may be immovably coupled to the inner base and spaced from the inner sidewall.

According to another aspect of the present disclosure, the is provided a method of forming a container for use with a diffuser cartridge. The method includes inserting an inner element into an outer sidewall, with the inner element having an inner base and an inner sidewall collectively defining an inner cavity. The inner sidewall is configured to define a first diameter adjacent the inner base and a second diameter spaced from the inner base that is less than the first diameter. A retaining wall is coupled to the inner base and is positioned within the inner cavity, with the retaining wall being engageable with the diffuser cartridge. The method further includes connecting the inner element to the outer sidewall. The inner sidewall and the outer sidewall are configured such that a gap extends between the inner sidewall and the outer sidewall when the inner element is connected to the outer element. The method additionally includes connecting an outer base to the outer sidewall.

According to another aspect of the present disclosure, there is provided a fluid container comprising an outer body having an opening, a closed base and a sidewall disposed between the opening and base. The container additionally includes an inner body having an opening, a closed base and sidewall disposed between the opening and base forming an inner volume for fluid storage therein. The outer sidewall and the inner sidewall are positioned about a central axis. The inner body has an upper portion, a lower portion and an intermediate portion, with the intermediate portion having a cross sectional area perpendicular to the central axis which is less than a cross sectional area perpendicular to the central axis of the upper portion and a cross sectional area perpendicular to the central axis of the lower portion. The inner body opening is interconnected to the outer body opening and the inner body is disposed within the outer body, such that the inner and outer bodies form a void therebetween.

The outer body may include an upper portion, a lower portion, and an intermediate portion, and the intermediate portion may have a cross sectional area perpendicular to the central axis which is less than a cross sectional area perpendicular to the central axis of the upper portion and a cross sectional area perpendicular to the central axis of the lower portion;

The cross sectional areas of the inner and/or outer bodies may include a diameter.

The void may be evacuated. The void may be filled with a gas of low thermal activity, such as air, oxygen, carbon monoxide, or carbon dioxide.

A diffuser retention element may be coupled to base of said inner body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a container including a cap and a main body, with the cap being separated from the main body;

FIG. 2 is a cross sectional view of the container with the cap connected to the main body and a diffuser cartridge connected to a retaining wall within the main body;

FIG. 3 is a cross sectional view of the main body, diffuser cartridge, and retaining wall;

FIG. 4 is an enlarged cross sectional view of the diffuser cartridge and retaining wall, and an enlarged, partial cross sectional view of the main body;

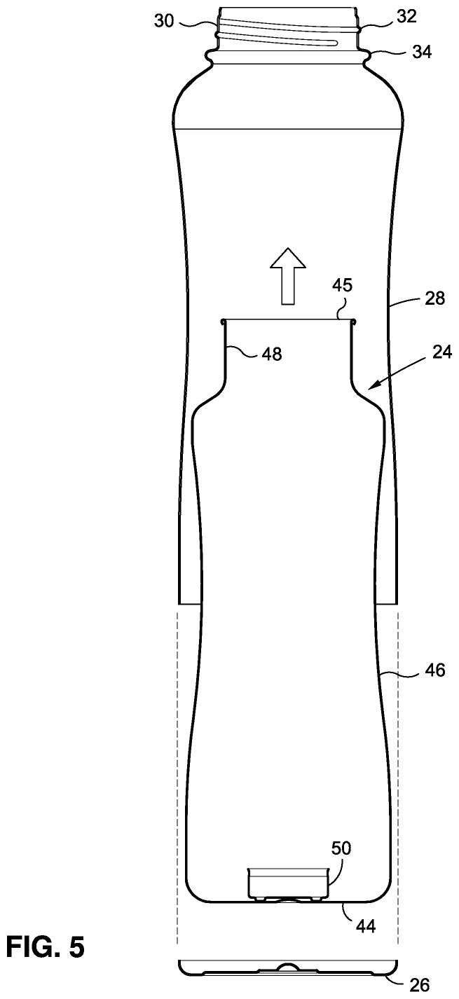

FIG. 5 is a cross sectional view depicting insertion of the inner element into the outer sidewall during assembly of the main body;

FIG. 6 is an upper perspective view of the diffuser cartridge;

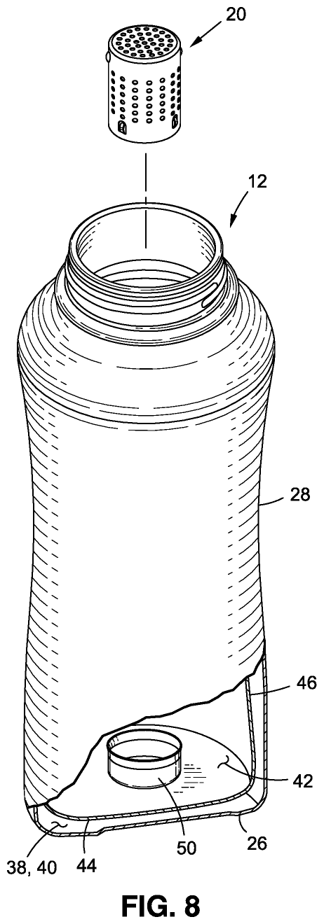

FIG. 7 is a lower perspective view of the diffuser cartridge;

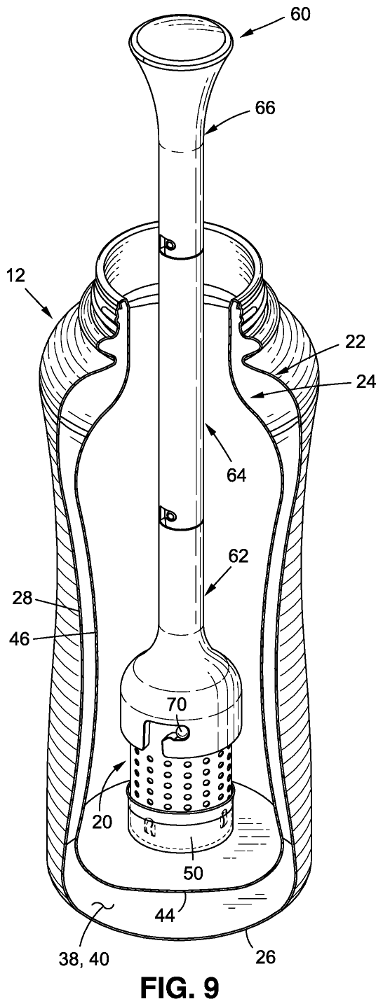

FIG. 8 is an upper perspective, partial cutaway, exploded view of the diffuser cartridge adapted to be nested within the retaining wall located within the main body;

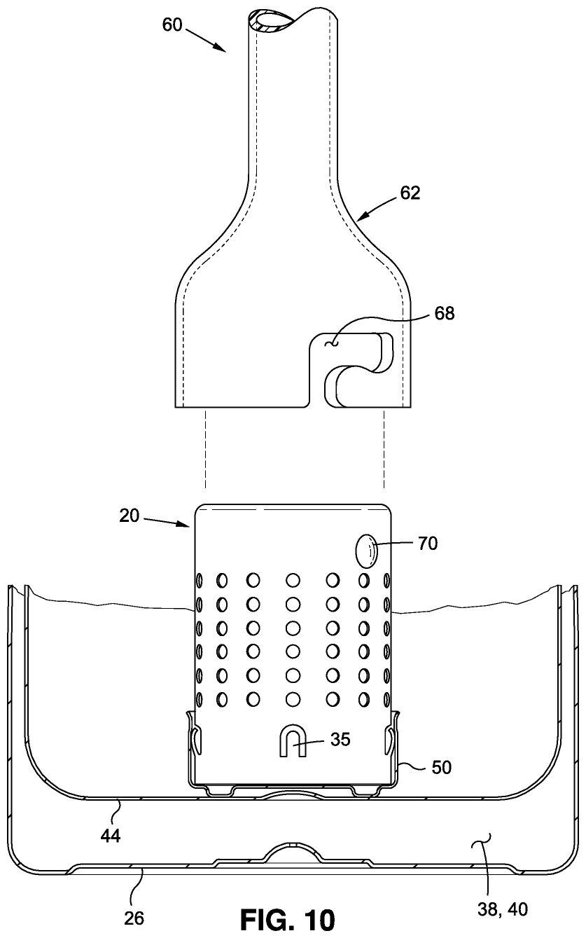

FIG. 9 is an upper perspective, partial cutaway view showing a tool engaged with the diffuser cartridge, with the diffuser cartridge being engaged with the retaining wall; and

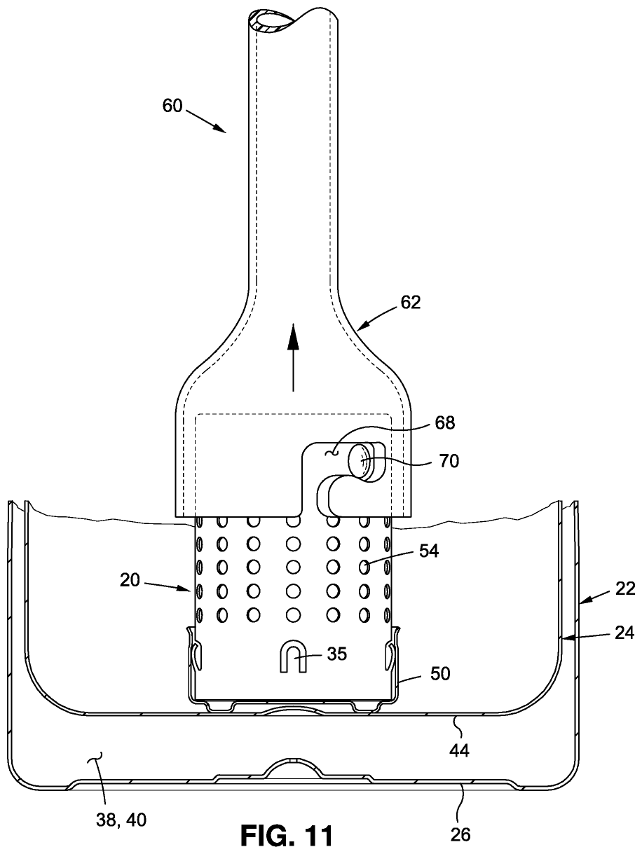

FIGS. 10-12 show a sequence of connecting the tool to the diffuser cartridge, and removing the diffuser cartridge from the main body using the tool.

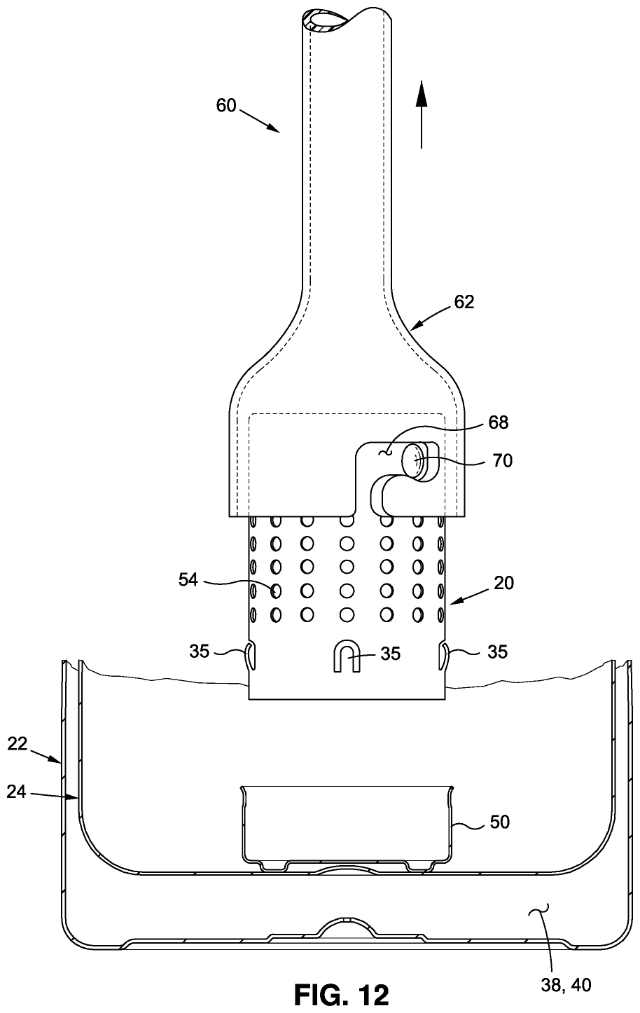

Common reference numerals are used throughout the drawings and the detailed description to indicate the same elements.

### DETAILED DESCRIPTION

Referring now to the drawings, wherein the showings are for purposes of illustrating a preferred embodiment of the present disclosure, and not for purposes of limiting the same, there is depicted a double walled container 10 for retaining drinking fluids, such as water, sports drinks, tea, coffee, etc. The incorporation of a double wall in the container 10 may provide a thermally insulating gap or barrier extending, at least partially, around an internal fluid retaining chamber. The double wall of the container 10 may be contoured to provide a desirable, ergonomic external configuration, while maximizing the volume of the internal fluid retaining chamber and promoting desired flow characteristics, as will be described in more detail below.

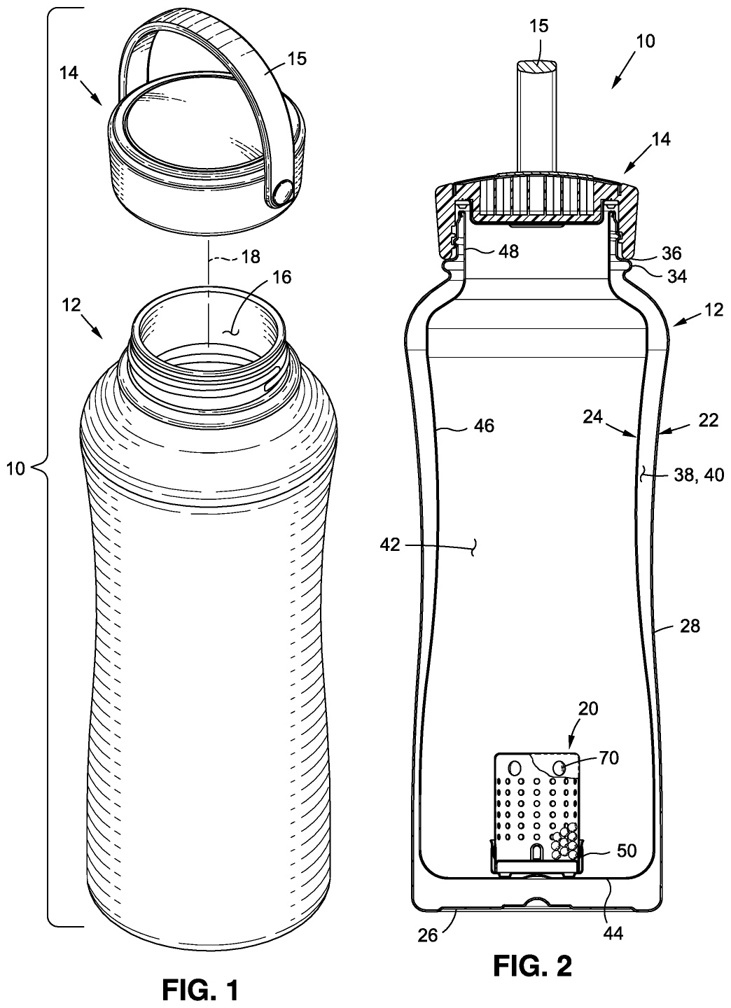

FIG. 1 shows the container 10, which generally includes a main body 12 and a cap 14 connectable to the main body 12. The main body 12 includes an opening 16, disposed about a central axis 18, with the opening 16 being configured to allow for filling of the main body 12 with a drinking fluid, as well as dispensing of the drinking fluid from the main body 12. The cap 14 may be connected to the main body 12 to close the opening 16, and removed from the main body 12 to uncover the opening 16. The cap 14 and the main body 12 may be selectively connected to each other via threaded engagement. The cap 14 may include a handle or strap 15 to facilitate gripping or holding of the container 10 when the cap 14 is connected to the main body 12.

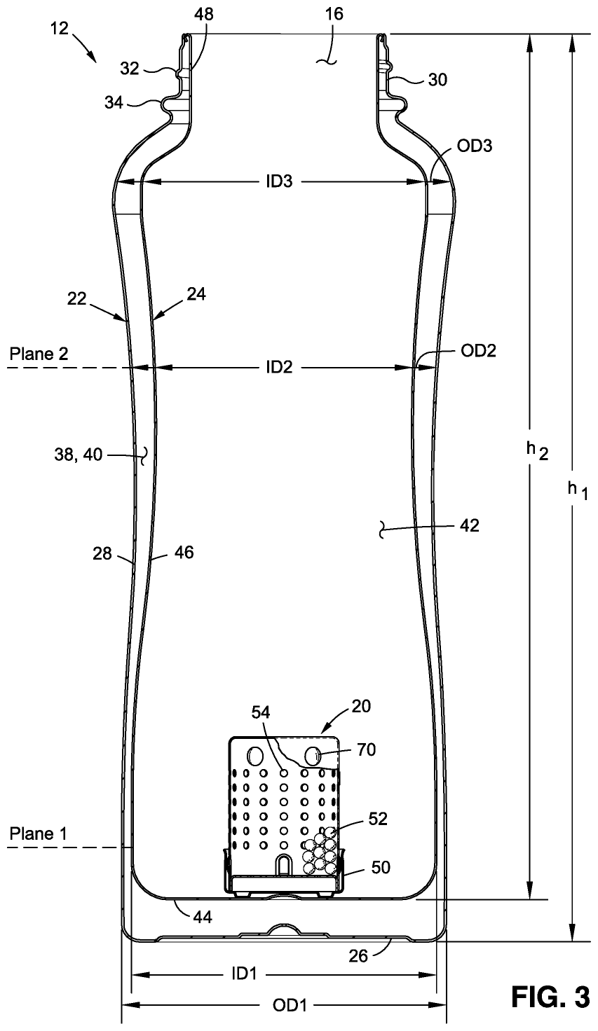

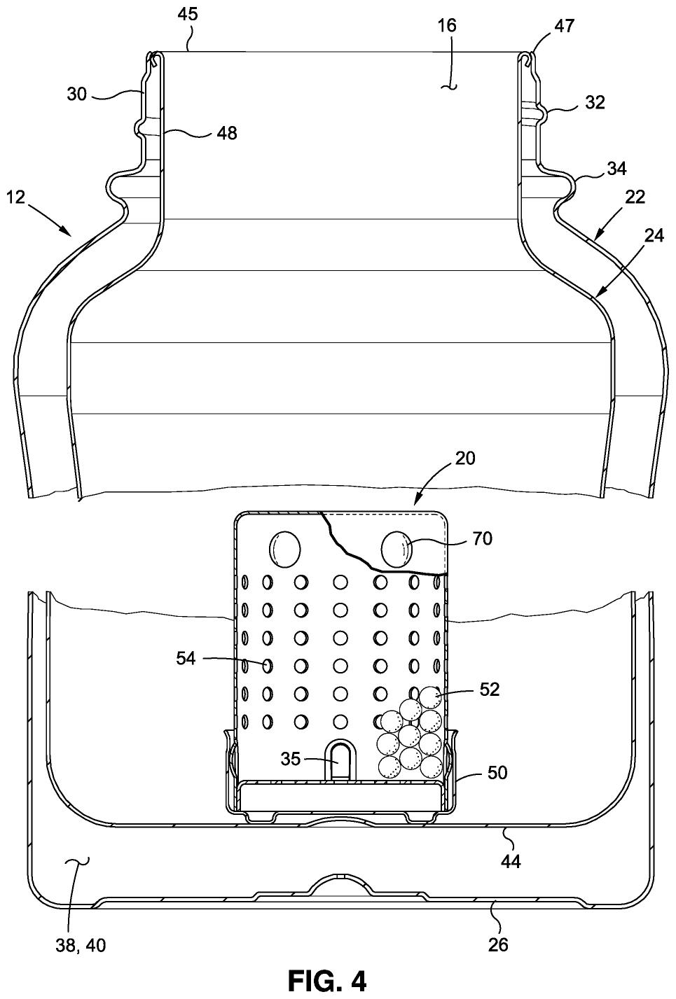

Referring now to FIGS. 2 and 3, there is depicted a cross sectional view of the container 10 to illustrate various internal structural features of the container 10, including the double wall configuration of the main body 12, as well as a removably detachable diffuser cartridge 20 capable of interacting with the fluid in the container 10 to treat the fluid. The particulars of the main body 12 will be discussed first, followed by a discussion of the diffuser cartridge 20.

The main body 12 of the container 10 includes an outer element 22 and an inner element 24 coupled to the outer element 22. The outer element 22 may include an outer base 26, and an outer sidewall 28 extending from the outer base 26. The outer base 26 may form an external bottom of the container 10, while the outer sidewall 28 may form an external side of the container 10. The outer base 26 may extend generally perpendicular to the central axis 18, while the outer sidewall 28 may circumnavigate the central axis 18. The outer sidewall 28 may be contoured to include a slightly curved configuration which results in the outer sidewall 28 having a variable diameter. In this regard, the diameter of the outer sidewall 28 may include a first diameter OD1 adjacent the outer base 26, a second diameter OD2 at a midsection of the outer sidewall 28, and a third diameter OD3 adjacent an upper end portion of the outer sidewall 28, e.g., opposite the outer base 26. The outer sidewall 28 is configured such that the second diameter OD2 is less than the first diameter OD1 and the third diameter OD3, which results in the midsection of the outer sidewall 28 having an external concave configuration. The concavity of the outer sidewall 28 may also provide an ergonomically desirable configuration to facilitate manual gripping of the container. The curved configuration resulting from the variability in the diameter of the outer sidewall 28 may also enhance the appearance of the container.

The outer element 22 may additionally include an outer neck 30 at an upper end of the container 10. The outer neck 30 may be integrally formed with the outer sidewall 28, and may be narrower than the outer sidewall 28. The outer neck 30 may be configured to include one or more threads 32 and a shoulder 34. The threads 32 may engage with corresponding threads on the cap 14, such that the cap 14 may be rotated in one direction to assume a closed position, and rotated in an opposing direction to transition from the closed position to a disengaged position. When the cap 14 is in the closed position, a bottom edge 36 of the cap 14 may engage with the shoulder 34.

The outer base 26, the outer sidewall 28, and the outer neck 30 may collectively define an outer cavity 38 or void within the outer element 22, the importance of which will be explained in more detail below.

The inner element 24 is connected to the outer element 22 and is smaller than the outer element 22, which allows the inner element 24 to reside within the outer cavity 38 of the outer element 22. As will be explained in more detail below, the inner element 24 and outer element 22 may be configured to define a gap 40 between the inner element 24 and outer element 22 to promote thermal insulation of the container.

The inner element 24 may define an internal cavity 42 for storing the drinking fluid, such as water. As such, the fluid storage capacity of the container 10 may be defined by the internal cavity 42 of the inner element 24. The inner element 24 may include an inner base 44 and an inner sidewall 46 extending from the inner base 44, with the inner base 44 and inner sidewall 46 collectively defining the internal cavity 42. The inner base 44 may form an internal bottom of the internal cavity 42, while the outer sidewall 28 may form an internal side of the internal cavity 42. The inner base 44 may extend generally perpendicular to the central axis 18, while the inner sidewall 46 may circumnavigate the central axis 18.

The inner sidewall 46 may be contoured to include a slightly curved configuration which results in the inner sidewall 46 having a variable diameter. In this regard, the diameter of the inner sidewall 46 may include a first diameter ID1 adjacent the inner base 44, a second diameter ID2 at a midsection of the inner sidewall 46, and a third diameter ID3 adjacent an upper end portion of the inner sidewall 46, e.g., opposite the inner base 44. The inner sidewall 46 is configured such that the second diameter ID2 is less than the first diameter ID and the third diameter ID3, which results in the midsection of the outer sidewall 28 having an external concave configuration and an internal convex configuration.

The curvature of the inner sidewall 46 may be slightly more pronounced than the curvature of the outer sidewall 28, which may result in variability in the size of the gap 40 at different cross sections along the height of the container. In particular, the ratio of the first diameter/second diameter (ID1/ID2) of the inner sidewall 46 may be greater than the ratio of the first diameter/second diameter (OD1/OD2) of the outer sidewall 28. In other words, the difference in magnitude between the first diameter ID1 and second diameter ID2 of the inner sidewall 46 may be greater than the difference in magnitude between the first diameter OD1 and the second diameter OD2 of the outer sidewall 28. The concavity of the inner sidewall 46 may be aimed at maintaining thermal insulation by providing a sufficient gap 40 between the inner sidewall 46 and the outer sidewall 28, while also providing enhanced fluid storage capacity and enhanced fluid flow through the diffuser cartridge 20, as will be described in more detail below.

The inner element 24 may additionally include an inner neck 48 at an upper end of the container. The inner neck may be integrally formed with the inner sidewall 46, and may be narrower than the inner sidewall 46. The inner base 44, the inner sidewall 46, and the inner neck 48 may collectively define the inner cavity 42.

According to one embodiment, the container 10 includes a retaining wall 50 connected to the inner element 24, and specifically the inner base 44. The retaining wall 50 is spaced from the outer base 26 at least by the thermal gap 40 extending between the inner base 44 and the outer base 26. The retaining wall 50 may include a cylindrical portion that is smaller in diameter than the inner sidewall 46 so as to create a gap or void between the retaining wall 50 and the inner sidewall 46. The diffuser cartridge 20 is detachably affixable/engageable to the retaining wall 50 and may include mineral agent beads 52 or other materials that can interact with and treat a fluid contained within the main body 12. The mineral agent beads 52 are secured within the cartridge 20 so as not to escape from the cartridge 20 and into the void of the main body 12. The exemplary cartridge 20 is of a cylindrical shape, although those skilled in the art will readily appreciate that the cartridge 20 may take on other shapes including, but not limited to a spherical shape, a cuboid shape, or any other shapes.

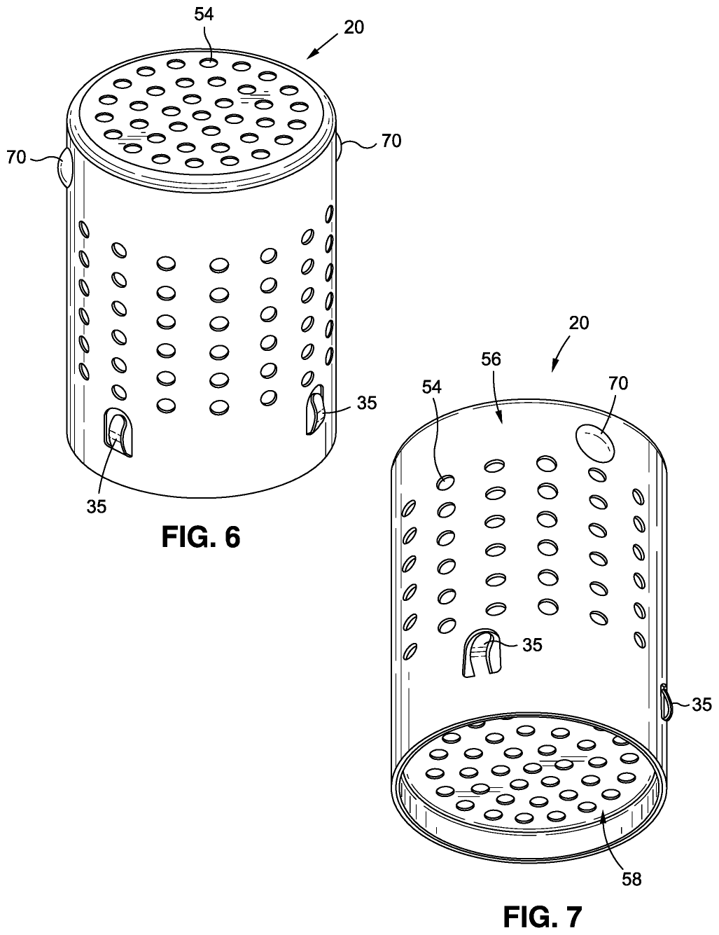

Prior to assembling the main body 12, the outer base 26 may be detached from the outer sidewall 28, and the inner base 44 may be detached from the inner sidewall 46. The retaining wall 50 may be connected to the inner base 44 via welding, mechanical fasteners, or with the use of adhesives known in the art. The inner base 44 may be welded or otherwise attached to the inner sidewall 46, such that the inner element 24 is in the assembled configuration shown in FIG. 5.

The assembled inner element 24 is then inserted into the outer sidewall 28. To accommodate such insertion, the portion of the inner element 24 that passes through the narrowest portion of the outer element 22 is of a smaller diameter than the narrowest portion of the outer element 22. The inner element 24 is advanced through the outer sidewall 28 until an upper rim 45 of the inner element 24 is adjacent an upper rim 47 of the outer element 22, and preferably with the upper rims 45, 47 forming a substantially flush, co-planar relationship. The inner neck 48 may be welded or otherwise secured to the outer neck 30 to preferably form a fluid tight seal therebetween. The outer base 26 may be secured to the outer sidewall 28 to cover the bottom of the outer element 22. A small hole may remain in the outer element 22, such as in the outer base, to allow a vacuum to be applied to the gap 40 formed between the outer and inner elements 22, 24 to enhance the thermal insulation of the container 10. Once the vacuum is applied, the hole used to apply the vacuum may be covered or capped to maintain the vacuum within the container 10.

As noted above, the main body 12 is configured for use with cartridge 20, which may include a plurality of perforations 54 formed therein. The perforations 54 may be sized relative to the mineral beads 52 so as to retain the mineral beads 52 within the cartridge 20, while at the same time allowing the beads 52 to be bathed within the water/fluid contained within the main body 12. The perforations 54 shown in the drawings are arranged in rows and columns, although the perforations 54 may be formed on the cartridge 20 in any arrangement or pattern. The cartridge 20 depicted in the Figures is a two-part assembly, with an upper body 56 and a lower body 58 that engages with the upper body 56. The two-part construction of the cartridge 20 facilitates insertion of the filtering beads 52 during manufacture of the cartridge 20. The lower body 58 includes an end wall having the perforations formed therein, and an annular wall extending from the end wall and engaging with the upper body 56. The upper body 56 include an open end portion which receives the lower body 58, with the upper body 56 having a slightly reduced diameter adjacent the open end portion so as to engage with and retain the lower body 58. The perforations 54 formed on the exemplary cartridge are formed in both the upper and lower bodies 56, 58. According to one embodiment, the cartridge 20 defines an outer diameter preferably between 0.5-2.0 inches, and more preferably equal to approximately 1.125 inches. Furthermore, the height of the cartridge 20 is preferably between 1.0-3.0 inches, and more preferably equal to approximately 1.6875 inches.

The cartridge 20 is adapted to engage with the retaining wall 50, which is configured to allow the cartridge 20 to be selectively engaged with the retaining wall 50 to affix the cartridge 20 to the main body 12. The cartridge 20 and the retaining wall 50 are configured to become sufficiently engaged with each other when the cartridge 20 is nested within the retaining cavity 32 so as to hold the cartridge 20 within the main body 12 as the user repeatedly tips the main body 12 to drink the water contained therein. In this regard, the cartridge 20 and the retaining wall 50 may be adapted to create such engagement via a friction-tight fit, spring-type tabs 35, locking rims, etc.

One aspect of the present disclosure is directed toward promoting fluid flow through the cartridge 20 while it is retained within the main body 12. In particular, the widening of the inner element 24 at the lower end portion thereof, which includes the portion surrounding the cartridge 20, may allow for more water to reside and flow through and around the cartridge 20. The widening of the inner element may be illustrated by comparing the configuration of the main body 12 within two different cross sectional planes at different heights of the main body 12. In FIG. 3, Plane 1 is identified as being located at the lower end portion of the main body, so as to pass through the cartridge 20, whereas Plane 2 is identified as being located within a middle region or midsection of the main body and spaced above the cartridge 20. Within Plane 1, the internal cavity 42 may occupy 90-96% of the outer cavity 38, while the gap 40 may occupy the remaining 4-10% of the outer cavity 38. In one particular implementation, as to Plane 1, the internal cavity 42 may occupy approximately 95% of the outer cavity 38, while the gap 40 may occupy the remaining approximately 5% of the outer cavity 38. Within Plane 2, the internal cavity may occupy 80-90% of the outer cavity 38, while the gap 40 may occupy the remaining 10-20% of the outer cavity 38. In one particular implementation, as to Plane 2, the internal cavity may occupy approximately 84% of the outer cavity 38, while the gap 40 may occupy the remaining approximately 16% of the outer cavity 38.

When comparing the configuration of the main body 12 within Plane 1 to the configuration of the main body 12 within Plane 2, the widening of the inner element 24 adjacent a lower end portion of the main body 12 results in the main body 12 within Plane 1 having a greater portion devoted toward increasing the fluid capacity and a lesser portion of the main body 12 being devoted toward thermal insulation relative to the that portion of main body 12 within Plane 2.

The increased diameter of the inner element 24 surrounding the cartridge 20 may allow for more water to flow through and around the cartridge 20 as the main body 12 is filled with water. In this regard, the flow of the entering water may cause turbulence in the bottom of the main internal cavity 42, which may cause the fluid flow through and around the cartridge. The enlarged volume surrounding the cartridge 20 may maintain the turbulent region of the water at or near the cartridge 20 for a longer period of time, thereby promoting flow through the cartridge 20. Furthermore, as the main body 12 is tipped to drink water from the main body 12, the water may flow through and around the cartridge 20.

According to one embodiment, the diffuser cartridge 20 may be inserted or removed from the container 10 through the use of a tool 60. The tool 60 may be elongate and formed from a plurality of separate tool elements, including a bottom element 62, and intermediate element 64, and a top element 66, which are configured to be detachably engageable with each other. The tool 60 is configured such that the tool 60 may be manually manipulated or held by an individual to insert or remove the diffuser cartridge 20 to or from the main body 12, with the tool 60 being configured to allow an individual's hand to remain outside of the main body 12 throughout the insertion or removal process. In this respect, the tool 60 and diffuser cartridge 20 collectively define a length, which is larger than the distance between the retaining wall 50 and the top of the main body 12, which allows a portion of the tool 60 to extend beyond the main body 24 when the tool 60 is engaged with the diffuser cartridge 20, and with the diffuser cartridge 20 nested within the retaining wall 50.

The bottom element 62 is adapted to interface with the diffuser cartridge 20 and with the intermediate element 64. A pair of diametrically opposed cutouts 68 are formed in the bottom element 62 to facilitate engagement with the diffuser cartridge 20. In particular, the diffuser cartridge 20 may include a pair of diametrically opposed nubs or protrusions 70 which may be received within a respective cutout 68 to operatively couple the bottom element 62 to the diffuser cartridge 20.

To insert the diffuser cartridge 20 into the main body 12, a user may assemble the tool 60 by connecting the intermediate element 64 to the bottom element 62 and the top element 66. Once the tool 60 is assembled, the user may attach the diffuser cartridge 20 to the tool 60 by aligning the cutouts 68 formed on the bottom element 62 with the nubs 70 formed on the diffuser cartridge 20. The user may advance the tool 60 over the cartridge 20, to allow the nubs 70 to pass through the axial segments 50 of the corresponding cutouts 68. The tool 60 may be rotated in a first direction to allow the nubs 70 to pass through the corresponding cutouts 68. Once the nubs 70 pass through both the axial and radial segments 50, 54, the diffuser cartridge 20 is attached to the tool 60.

The diffuser cartridge 20 is then inserted into the main body 12 by holding the tool 60 at the top element 66 and aligning the diffuser cartridge 20 and bottom element 62 of the tool 60 with the opening of the main body 12. The user lowers the tool/cartridge assembly into the main body 12 until the diffuser cartridge 20 reaches the retaining wall 50. When the diffuser cartridge 20 is aligned with the retaining wall 50, the user presses/pushes the tool 60 therein until the diffuser cartridge 20 is nested within the retaining wall 50. Once the diffuser cartridge 20 is secured/nested within the retaining wall 50, the user rotates the tool 60 in a second direction opposite to the first direction and then lifts the tool 60, which causes the nubs 70 to retreat back through the cutouts 68 formed in the bottom element 62, and disengage the tool 60 from the diffuser cartridge 20. The tool 60 is then completely removed from the main body 12, and the user may continue using the main body 12 with the diffuser cartridge 20 secured therein.

To remove the diffuser cartridge 20, the user again assembles the tool 60, as described above, if the tool 60 is disassembled. The assembled tool 60 is then inserted into the main body 12 until the bottom element 62 reaches the diffuser cartridge 20. The user then rotates the tool 60 to align the cutouts 68 with the nubs 70. Once the nubs 70 are aligned, the user presses down and then rotates the tool 60 in the first direction to allow the nubs 70 to pass through the cutouts 68, and ultimately, secure the tool 60 to the diffuser cartridge 20. The user then holds the main body 12 in one hand, and pulls on the tool 60 to overcome the engagement force holding the diffuser cartridge 20 to the retaining wall 50, thereby releasing the diffuser cartridge 20 from the retaining wall 50. The user then pulls the tool/cartridge assembly from the main body 12 until the tool 60 and diffuser cartridge 20 are completely removed from the main body 12.

The above description references the use of a diffuser cartridge for treating the drinking fluid. For more information regarding the use of a diffuser cartridge, and the interaction between the diffuser cartridge and the retaining wall, please refer to U.S. Pat. No. 9,688,445 issued Jun. 27, 2017 to Ayres et al. and entitled Fluid Container with Internal Perforated Compartment, the contents of which are expressly incorporated herein by reference. Furthermore, the above description describes the use of a tool for inserting and removing the diffuser cartridge. For more information regarding the use of the tool, please refer to Ayres, U.S. Patent Application Publication No. 2017/0173769, published Jun. 22, 2017 and entitled Fluid Container Diffuser System and Related Method of Use, the contents of which are expressly incorporated herein by reference.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A container for holding drinking fluids, the container being usable with a diffuser cartridge, the container comprising:
an outer element having an outer base and an outer sidewall collectively defining an outer cavity;
an inner element having an inner base and an inner sidewall collectively defining an inner cavity, the inner element being coupled to the outer element and disposed within the outer cavity and sized in relation to the outer element such that a gap extends between the inner element and the outer element, the inner sidewall being configured to define a first diameter adjacent the inner base and a second diameter spaced from the inner base that is less than the first diameter; and
a retaining wall coupled to the inner base and engageable with the diffuser cartridge.

2. The container recited in claim 1, wherein the outer sidewall is of a third diameter adjacent the outer base and is of a fourth diameter at a midsection thereof spaced from the outer base, the fourth diameter being less than the third diameter.

3. The container recited in claim 1, wherein the outer sidewall and the inner sidewall are positioned about a central axis, the distance between the outer sidewall and the inner sidewall varying within different cross sections taken perpendicular to the central axis.

4. The container recited in claim 3, wherein the outer sidewall and the inner sidewall are configured such that the gap defines a first area in a first cross section taken perpendicular to the central axis adjacent the inner base and a second area in a second cross section taken perpendicular to the central axis spaced from the inner base, the first area being less than the second area.

5. The container recited in claim 1, wherein the outer sidewall includes an external concave configuration.

6. The container recited in claim 1, wherein the inner sidewall includes an internal convex configuration.

7. The container recited in claim 1, wherein the gap is of a fluid pressure having a magnitude of less than atmospheric pressure.

8. The container recited in claim 1, wherein the inner base is separated from the outer base, such that a portion of the gap extends therebetween.

9. The container recited in claim 1, wherein the retaining wall is cylindrical.

10. The container recited in claim 1, wherein the at least a portion of the retaining wall is immovably coupled to the inner base and is spaced from the inner sidewall.

11. A container for holding drinking fluids, the container comprising:
an outer element having an outer base and an outer sidewall collectively defining an outer cavity;
an inner element having an inner base and an inner sidewall collectively defining an inner cavity, the inner element being coupled to the outer element and disposed within the outer cavity and sized in relation to the outer element such that a gap extends between the inner sidewall and the outer element and between the inner base and the outer element, the inner sidewall being configured to define a first diameter adjacent the inner base and a second diameter spaced from the inner base that is less than the first diameter;
a retaining wall coupled to the inner base and engageable with the diffuser cartridge; and
a diffuser cartridge releasably engageable with the retaining wall.

12. The container recited in claim 11, wherein the outer sidewall is of a third diameter adjacent the outer base and is of a fourth diameter at a midsection thereof spaced from the outer base, the fourth diameter being less than the third diameter.

13. The container recited in claim 12, wherein the outer sidewall and the inner sidewall are positioned about a central axis, the outer sidewall and the inner sidewall being configured such that the gap defines a first area in a first cross section taken perpendicular to the central axis adjacent the inner base and a second area in a second cross section taken perpendicular to the central axis spaced from the inner base, the first area being less than the second area.

14. The container recited in claim 11, wherein the outer sidewall and the inner sidewall are positioned about a central axis, the distance between the outer sidewall and the inner sidewall varying within different cross sections taken perpendicular to the central axis.

15. The container recited in claim 11, wherein the outer sidewall includes an external concave configuration.

16. The container recited in claim 11, wherein the inner sidewall includes an internal convex configuration.

17. The container recited in claim 11, wherein the gap is of a fluid pressure having a magnitude of less than atmospheric pressure.

18. The container recited in claim 11, wherein at least a portion of the retaining wall is immovably coupled to the inner base.

19. The container recited in claim 11, wherein the inner base is separated from the outer base, such that a portion of the gap extends therebetween.

20. A method of forming a container for use with a diffuser cartridge, the method comprising the steps of:
inserting an inner element into an outer sidewall, the inner element having an inner base and an inner sidewall collectively defining an inner cavity, the inner sidewall being configured to define a first diameter adjacent the inner base and a second diameter spaced from the inner base that is less than the first diameter, a retaining wall being coupled to the inner base and positioned within the inner cavity, the retaining wall being engageable with the diffuser cartridge;
connecting the inner element to the outer sidewall, the inner sidewall and the outer sidewall being configured such that a gap extends between the inner sidewall and the outer sidewall when the inner element is connected to the outer element; and
connecting an outer base to the outer sidewall.

21. A fluid container comprising:
an outer body having an opening, a closed base and a sidewall disposed between the opening and base;
an inner body having an opening, a closed base and sidewall disposed between the opening and base forming an inner volume for fluid storage therein;
wherein the sidewall of the outer body and the sidewall of the inner body are positioned about a central axis;
wherein the inner body has an upper portion, a lower portion and an intermediate portion, said intermediate portion having a cross sectional area perpendicular to the central axis which is less than a cross sectional area perpendicular to the central axis of the upper portion and a cross sectional area perpendicular to the central axis of the lower portion; and
wherein the inner body opening is interconnected to the outer body opening and the inner body is disposed within the outer body and said inner and outer bodies form a void therebetween;

22. The fluid container of claim 21 wherein the outer body has an upper portion, a lower portion and an intermediate portion, said intermediate portion having a cross sectional area perpendicular to the central axis which is less than a cross sectional area perpendicular to the central axis of the upper portion and a cross sectional area perpendicular to the central axis of the lower portion;

23. The fluid container of claim 21 wherein the cross sectional areas include a diameter.

24. The fluid container of claim 22 wherein the cross sectional areas include a diameter.

25. The fluid container of claim 21 wherein the said void is evacuated.

26. The fluid container of claim 21 wherein said void is filled with a gas of low thermal activity.

27. The fluid container of claim 21 wherein a diffuser retention element is coupled to base of said inner body.
